(19) United States
(12) Patent Application Publication
(10) Pub. No.: US 2008/0282769 A1
(43) Pub. Date: Nov. 20, 2008

(54) APPARATUS AND METHOD FOR SHIELDING A SOOT SENSOR

(76) Inventor: Charles Scott Nelson, Fenton, MI (US)

Correspondence Address: CANTOR COLBURN, LLP, 20 Church Street, 22nd Floor, Hartford, CT, 06103, US

(21) Appl. No.: 11/750,883

(22) Filed: May 18, 2007

(51) Int. Cl. G01N 7/00

(52) U.S. Cl. 73/23.31

(57) ABSTRACT

A soot sensor, comprising: a sensing element configured to provide a signal indicative of an amount of soot detected by the sensing element, the sensing element terminating at a tip portion; a shield disposed about the sensing element, the shield comprising an elongated body having a solid side wall terminating at a distal end portion, and a single opening disposed completely across the distal end portion, the single opening having a peripheral edge defined by the distal end portion of the side wall; and an inner area defined by the shield, the area being in fluid communication with the single opening and the tip portion being completely recessed within the area at a distance from the single opening and a peripheral edge of the tip portion being at least a predetermined distance from the solid side wall, the predetermined distance preventing soot from completely blocking the single opening.

### BACKGROUND

Exemplary embodiments of the present invention relate to an apparatus and method for shielding a gas sensor. More particularly, exemplary embodiments of the present invention relate to a soot sensor and a shield for a soot sensor.

Soot sensors are often located upstream from a diesel particulate filter wherein the sensor is exposed to fluid flows having soot particles entrained in the gases flowing past the sensing element. The sensing element of a soot sensor is configured to provide signals indicative of the amount of soot in the flow path or alternatively that the sensor has been exposed to soot (e.g., a soot sensor located down stream from a filter such as a diesel particulate filter (DPF)).

A soot sensor is meant to have soot deposited on its sensing surfaces in order to cause a signal to be generated by the sensor. The sensing element is located within a protective shield that provides fluid communication to the sensing element of the soot sensor. The shield will have a plurality of openings in the sidewalls of the shield to provide such fluid communication. However, if the soot forms on the exterior surface of the protective shield, the openings of the shield may become plugged or clogged preventing soot from contacting the soot sensing element disposed within the shield thereby rendering the sensor ineffective. Furthermore, the sensing element will not be able to generate enough heat to oxidize the soot particles disposed on the exterior surface of the shield.

Accordingly, it is desirable to provide a soot sensor with a shield that will allow fluid communication with a sensing element within the shield as well as preventing the shield from becoming completely clogged with soot

### SUMMARY OF THE INVENTION

In accordance with an exemplary embodiment of the present invention a shield assembly for a gas sensor is provided. In one exemplary embodiment, a soot sensor is provided the soot sensor, comprising: a sensing element configured to provide a signal indicative of an amount of soot detected by the sensing element, the sensing element terminating at a tip portion; a shield disposed about the sensing element, the shield comprising an elongated body having a solid side wall terminating at a distal end portion, and a single opening disposed completely across the distal end portion, the single opening having a peripheral edge defined by the distal end portion of the side wall; and an inner area defined by the shield, the area being in fluid communication with the single opening and the tip portion being completely recessed within the area at a distance from the single opening and a peripheral edge of the tip portion being at least a predetermined distance from the solid side wall, the predetermined distance preventing soot from completely blocking the single opening.

### BRIEF DESCRIPTION OF THE DRAWINGS

FIG. 1 is a cross sectional view of a soot sensor in accordance with an exemplary embodiment of the present invention;

FIG. 2 is a view along lines 2-2 of FIG. 1;

FIG. 3 is a perspective view of a soot sensor shield in accordance with an exemplary embodiment of the present invention;

FIG. 4 is a perspective view of a soot sensor shield in accordance with an alternative exemplary embodiment of the present invention;

FIG. 5 is a schematic illustration of a soot sensing system utilizing a soot sensor in accordance with an exemplary embodiment of the present invention;

FIG. 6 is a perspective view of a sensing element for use with a soot sensor shield of exemplary embodiments of the present invention;

FIG. 7 is a graph illustrating the relationship of soot and sensor resistivity; and

FIG. 8 is a graph illustrating operation of various soot sensors including exemplary embodiments of the present invention employing shields having various configurations versus time.

### DETAILED DESCRIPTION OF EXEMPLARY EMBODIMENTS

In accordance with an exemplary embodiment of the present invention, a shield assembly is disposed about a sensing element or member of a soot sensor. Exemplary embodiments of the present invention are related to a shield for a soot sensing element that is not susceptible to plugging or clogging by soot. In accordance with an exemplary embodiment of the present invention a single opening is located on a lower portion of the shield wherein the opening is too large for the weak particulate matter to bridge the gap and effectively seal the opening.

In accordance with an exemplary embodiment of the present invention, the shield comprises an elongated body having a solid side wall terminating at an end portion with a single opening disposed at the end portion. In other words, the solid side wall has no openings located therein and a single large opening is positioned at the end of the side wall. The single opening is defined by and extends from the end portion of the side wall.

In accordance with an exemplary embodiment of the present invention, a tip portion of the sensing element is located within an area defined by the shield and the tip portion is positioned a distance from the single opening. Thus, the sensing element is recessed within an area defined by the shield.

This distance is determined by the amount of soot depositing desired and the need to protect the sensing element from physical damage that may occur from particulates in the gas flowing past the sensor.

In accordance with an exemplary embodiment of the present invention pressure pulsations in the exhaust stream caused by the various cylinders exhaust strokes will force exhaust particulate matter up into the bottom opening to be contacted with the sensing element.

The gas sensor shield is disposed over the sensing element of the gas sensor. In accordance with an exemplary embodiment of the present invention, the sensing element of the gas sensor is disposed through a central body, a lower shell and into the sensor shield that is connected to the lower shell. The opposite end of the sensing element is electrically connected to a wiring harness that communicates with a microcontroller or microprocessor of a sensing system the gas sensor is coupled to (e.g., vehicle engine control module or other equivalent system). During operation, the gas sensor is disposed in a gas stream with the sensing element in operable communication with the vehicle via the wiring harness. Gas in the gas stream enters the shield via the opening disposed in the tip thereof. Once in the shield, the gas contacts the sensing element that employs electrodes and an electrolyte to determine whether an amount of soot is the gas stream.

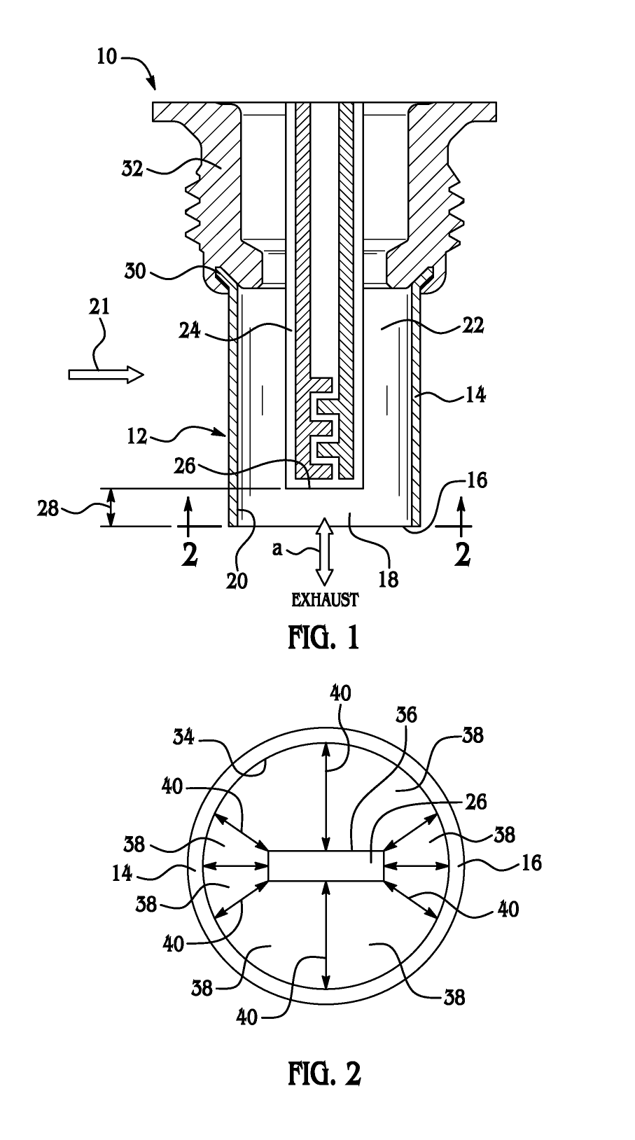

Referring now to FIGS. 1 and 2 and in accordance with an exemplary embodiment, a gas sensor 10 with a shield 12 is shown. The gas sensor shield comprises a body 14 having solid sides terminating at a distal end portion 16. The shield has a single opening 18 disposed completely across the distal end portion. In accordance with an exemplary embodiment of the present invention, the single opening has a peripheral edge 20 defined by the distal end portion of the side wall. In addition and in accordance with an exemplary embodiment of the present invention the single opening is large enough to prevent soot from clogging the same. Moreover and in one exemplary embodiment, the single opening extends completely across the distal end portion of the shield.

In one non-limiting exemplary embodiment, the distal end portion of the side wall and the opening in the shield are arranged to be approximately perpendicular to an exhaust flow path illustrated by arrow 21.

In accordance with an exemplary embodiment of the present invention, an area 22 is defined by the shield. The area 22 is in fluid communication with the single opening. In accordance with an exemplary embodiment shield 12 comprises a single or multiple layers of heat-resistant materials, such as ferrous materials (e.g., high temperature stainless steel or the like). The shield can be formed by any suitable processes, such as deep drawing, extrusion, welding, spin forming, and the like.

Soot sensor 10 has a sensing element 24 configured to provide a signal indicative of an amount of soot detected by the sensing element. The sensing element terminates at a tip portion 26.

In accordance with an exemplary embodiment of the present invention, the tip portion is completely recessed within the area at a distance 28 from the single opening. In accordance with an exemplary embodiment of the present invention a distance that has been shown to be suitable in exemplary embodiments is approximately 2.0 millimeters (mm) or greater. Another suitable distance 28 is 8.0 mm. Of course, distances greater or less than 2.0 mm are considered to be within the scope of exemplary embodiments of the present invention. In addition, the recessed nature of the tip portion also prevents soot clogging of the single opening.

The shield is attached to a soot sensor such as by welding, crimping, or the like. As illustrated, the shield is configured to completely cover the sensing element wherein fluid communication to the sensing element is only provided by the single opening. The general shape of the shield and its side walls may comprise any suitable configuration (e.g., circular, oblong, and the like and/or multi-sided e.g., triangular, rectangular, square, trapezoidal, rectilinear, hexagonal, octagonal, pentagonal, and the like).

When the sensor is installed in the exhaust of an internal combustion engine or other device, it is generally installed so that the exhaust gasses impinge against the shield and sensing element in a direction approximately perpendicular to the axis (a) of the sensor. The gasses enter the shield through the single opening 18 to contact sensing element. Again and in one non-limiting exemplary embodiment, the single opening and the distal end of the side wall is arranged in a plane perpendicular to the exhaust flow path. Of course, other configurations are contemplated to be with the scope of exemplary embodiments of the present invention and that the aforementioned arrangement is one of many possible configurations.

Shield 12 is secured to the soot sensor by securing a flange member 30 to a shell portion 32 of the gas sensor. In an exemplary embodiment, flange member 30 is secured to the shell portion of the gas sensor via any suitable attachment process. For example, flange member 30 is secured to the shell portion by a cold forming process wherein a portion of the shell member is overmolded or pushed onto flange member 30 wherein flange member 30 is surrounded and secured to a portion of an outer shell of a gas sensor.

As illustrated in FIG. 2, tip portion 26 of the sensing element is spaced away from an inner peripheral wall 34 that also defines outer periphery 20 of opening 18. As shown an outer periphery 36 of the sensing element tip portion is spaced away from the outer periphery of the opening or inner peripheral wall 34, which in this embodiment are one in the same. Accordingly, the periphery of the tip portion 26 is surrounded by a gap or space 38. In accordance with an exemplary embodiment of the present invention, the shield and the tip portion are configured and positioned such that a dimension of space or gap 38 is not less than a predetermined distance, which has been shown to prevent soot particles from bridging the gap between the two and ultimately clogging or sealing opening 18, which will make the sensor ineffective. One dimension of gap 38 that has been shown to be effective in preventing soot clogging is 1.5 mm or greater. Other minimum dimensions of gap 38 include 2.0 millimeters (mm) and greater in order to prevent soot clogging.

In addition, and depending on the configuration of the sensing element tip and the configuration shield (e.g., rectangular tip and cylindrical tube shown in FIGS. 1 and 2) the shield is configured such that the varying distances (illustrated by arrows 40) between the outer periphery of the opening and the inner wall of the shield are greater than the predetermined distance, which has been shown to prevent soot particles from bridging the gap between the two and ultimately clogging or sealing opening 18. However and in this configuration the smallest of the varying distances illustrated by arrows 40 is at least 1.5 mm.

In accordance with an exemplary embodiment of the present invention the dimension of an opening (circular or otherwise) will be at least 3.0 mm and greater than a largest single dimension traversing the tip portion of the sensing element from one edge of the peripheral edge of the tip portion to another peripheral edge of the tip portion. For example, and in one non-limiting exemplary embodiment and if the opening 18 is circular and the periphery of the tip portion of the sensing element is rectangular the dimension of the opening will be at least 3 mm greater than a largest single dimension traversing the tip portion of the sensing element from one edge of the peripheral edge of the tip portion to another peripheral edge of the tip portion, which in this case would be diagonally from one corner of the rectangle to another opposite corner (e.g., if the dimensions of the rectangular peripheral edge are 4.0 mm×1.5 mm, the corresponding largest single dimension would be approximately 4.27 mm and thus, the diameter of the opening would be 7.27 mm or greater to provide at least 1.5 mm of space between the outer peripheral edge of the sensing element and the inner wall of the shield defining the opening 18). In addition, and at the smallest dimension (e.g., 1.5 mm) the amount of unoccupied space between the outer peripheral edge of the sensing element and the inner wall of the shield defining the opening 18 would be approximately 2.885 mm.

This, of course, presumes the sensing element is centrally located in the area defined by the shield. On the other hand and if the sensing element is not centrally located the opening 18 will still be configured to be spaced at least 1.5 mm from the edges of the periphery of the tip portion. Moreover and if the sensing element is circular the amount of unoccupied space would be more uniform about the peripheral edge of the sensing element.

Of course it is understood that the sensing element tip and soot sensor shield will have varying configurations different from those illustrated in FIGS. 1 and 2. In accordance with an exemplary embodiment of the present invention a distance that has been shown to be effective in preventing soot particles from bridging the gap between the sensor tip and the shield wall is approximately 1.5 millimeters (mm). Of course, distances greater or less than 1.5 mm are considered to be within the scope of exemplary embodiments of the present invention.

In an exemplary embodiment, the shield is a substantially tubular shaped member. Of course, other non-tubular configurations are contemplated to be within the scope of exemplary embodiments of the present invention. Non-limiting materials contemplated for the shield assembly are “300” and “400” series high-temperature stainless steel and equivalents thereof.

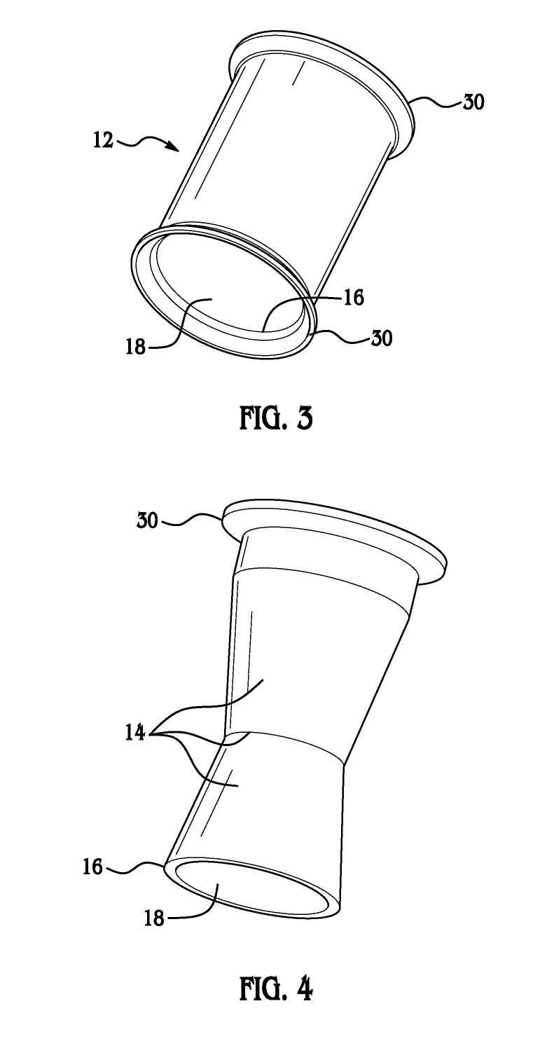

Referring now to FIG. 3 an alternative exemplary embodiment of the present invention is illustrated here shield 12 is configured to have a pair of flanges 30 at either end of the side walls of the shield. Accordingly, the shield has a symmetrical configuration, which assists in the associated manufacturing processes as either end of the shield may be secured to the shell of the sensor. Furthermore one of the flanges disposed at end 16 will also deflect and/or prevent soot from accumulating and clogging opening 18 as the flange will provide a deflecting member for fluid flowing past the shield (e.g., in one exemplary embodiment the fluid will be flowing in a direction substantially perpendicular to the side walls of the shield).

Referring now to FIG. 4, yet an alternative exemplary embodiment of the present invention is illustrated. Here the side wall 14 of shield 12 is configured to have a varying outer peripheral dimension, which will also vary the inner dimension of the side wall and the outer periphery of the opening as well as providing characteristics and/or configurations suitable for fluid flowing past the shield.

Of course, the shield illustrated in FIGS. 3 and 4 are examples of non-limiting alternative exemplary embodiments and other variations of the shield are contemplated as long as a large opening is defined at the end portion of the shield and the side walls are solid (e.g., no openings).

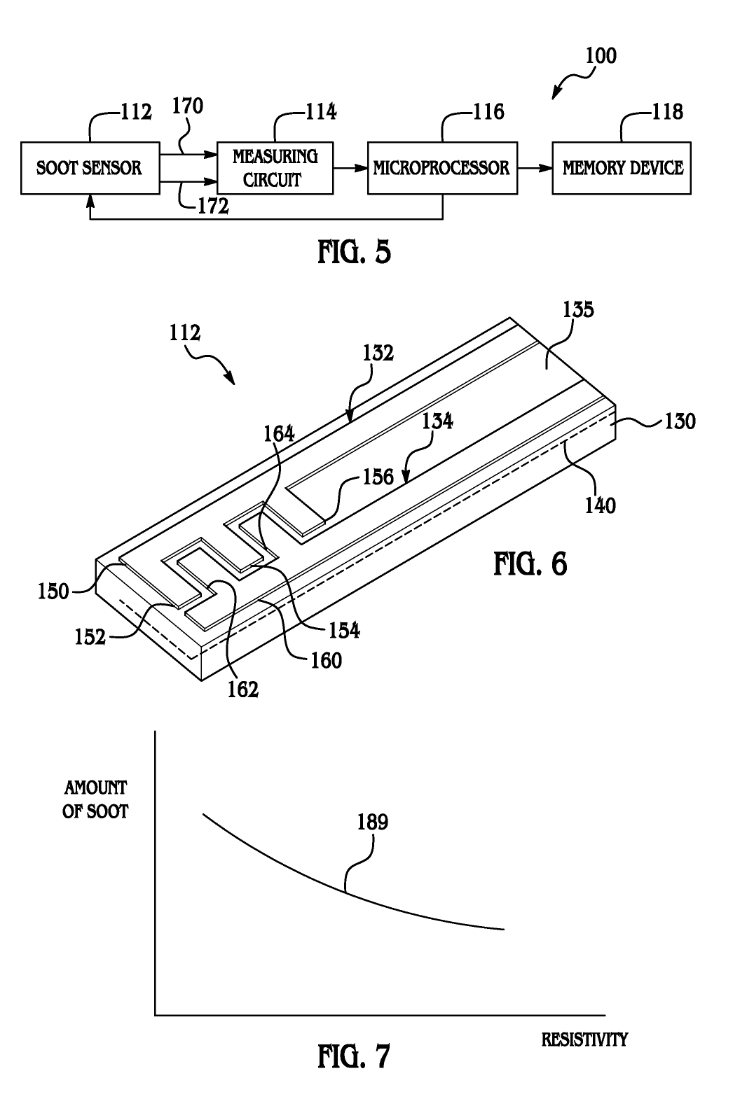

Referring now to FIGS. 5 and 6, a soot sensing system 100 for detecting an amount of soot in an exhaust stream is illustrated. The soot sensing system includes a soot sensor 112, a measuring circuit 114, a microprocessor 116, and a memory device 118.

The soot sensor is provided to detect an amount of soot in an exhaust stream communicating with the soot sensor. The soot sensor includes a nonconductive substrate 130, electrodes 132, 134, protective layers 136, 138 and a heater 140.

The nonconductive substrate has a generally rectangular shape. Of course in alternative embodiments, the nonconductive substrate could have alternate shapes known to those skilled in the art. The nonconductive substrate is constructed from an electrically nonconductive material. For example, in one exemplary embodiment the nonconductive substrate is constructed from alumina. Of course in alternative embodiments, the nonconductive substrate could be constructed from other electrically nonconductive materials known to those skilled in the art.

Electrode 132 is disposed on a surface 135 of the nonconductive substrate. The electrode includes a body portion 150 and finger portions 152, 154, 156. The electrode 132 is constructed from an electrically conductive material. For example, in one exemplary embodiment, the electrode 132 is constructed from a platinum layer deposited on the surface 135. Of course, in alternative embodiments the electrode 132 could be constructed from other electrically conductive materials known to those skilled in the art, such as gold, silver, copper, or combinations thereof for example. The body portion 150 has a generally rectangular shape extending longitudinally along the surface 135. The finger portions 152, 154, 156 are generally rectangular shaped and extend from the body portion 150 generally parallel to one another and spaced apart from one another.

Electrode 134 is also disposed on surface 135 and is spaced apart from electrode 132. Similar to electrode 132, electrode 134 is constructed from an electrically conductive material and includes a body portion 160 and finger portions 162, 164. As illustrated body portion 160 has a generally rectangular shape extending longitudinally along surface 135 and finger portions 162, 164 are configured and positioned to be interdigitated with finger portions 152, 154, 156 of electrode 132.

In accordance with an exemplary embodiment of the present invention an electrical parameter between electrodes 132, 134 is utilized to determine an amount of soot that has been deposited on the soot sensor, which is indicative of an amount of soot in an exhaust stream communicating with the sensor. In one exemplary embodiment, the electrical parameter is a resistivity level between electrodes 132, 134 wherein and when soot is deposited between the electrodes 132, 134, a relatively high resistance electrical short is obtained between the electrodes and as additional soot is deposited on the sensor 112 proximate to the interlaced fingers of the electrodes a resistivity level between the electrodes is reduced. Accordingly, the resistivity level between the electrodes can be utilized to calculate the amount of soot that has been deposited on the sensor. Of course, in alternative embodiments other electrical parameters could be utilized to determine the amount of soot deposited on the sensor, such as conductivity level or a capacitance level between the electrodes for example. A non-limiting example of a soot sensor is found in U.S. patent application Ser. No. 11/749,262, the contents of which are incorporated herein by reference thereto.

A heater or heating coil 140 is disposed within the nonconductive substrate and is provided to maintain the soot sensor 112 within a desired temperature range as is known in the related arts. In particular, heating coil 140 generates heat in response to a signal received from the microprocessor 116. The heater 140 can also periodically increase the temperature of the soot sensor to at least 550 degrees Celsius to burn off the collected soot on the soot sensor.

The measuring circuit is provided to measure the electrical parameter between the electrodes of the soot sensor, which is indicative of an amount of soot deposited on the sensor. As shown, the measuring circuit is electrically coupled to the electrodes via the conductive lines 170, 172, respectively. Further, the measuring circuit is electrically coupled to the microprocessor. During operation, the measuring circuit applies a voltage between the electrodes and in response to the applied voltage, an electrical current flows through the electrode 132, the soot deposited between the electrodes 132, 134, the electrode 134 to the measuring circuit 114. The measuring circuit 114 generates a signal indicative of the resistivity level between the electrodes 132, 134, based on an amount of the electrical current. Further, the microprocessor 116 receives the signal from the measuring circuit 114.

The microprocessor is configured to determine an amount of soot deposited on the soot sensor based on a signal from the measuring circuit. In particular, when the microprocessor receives the signal indicative of a resistance level between the electrodes from the measuring circuit, the microprocessor calculates an amount of soot utilizing the following equation: amount of soot=f(resistivity level), where f corresponds to an arithmetic function. Referring to FIG. 7, a curve 189 illustrates a relationship between an amount of soot deposited on the sensor and the resistivity level between the electrodes. The microprocessor is further configured to store a value indicative of the resistivity level between the electrodes in the memory device. The microprocessor is further configured to generate a signal that is received by the heating coil to maintain a temperature of the soot sensor within a desired temperature range.

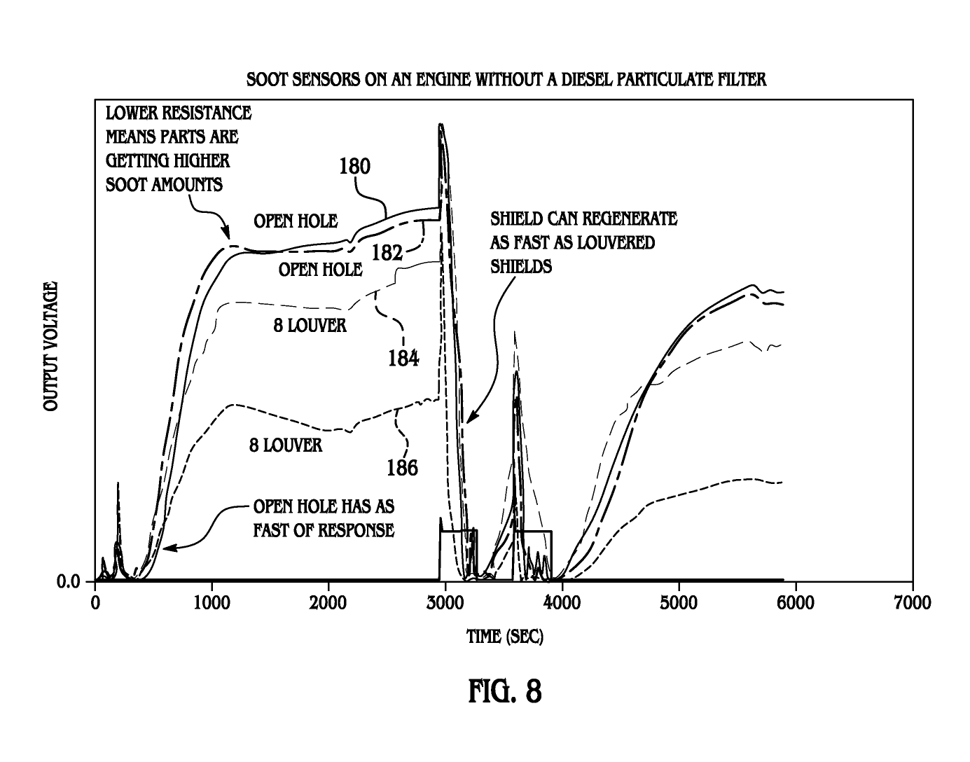

Referring now to FIG. 8 a graph is provided wherein various soot sensors and sensing elements have been tested. Lines 180 and 182 represent sensors using shields in accordance with exemplary embodiments of the present invention wherein in lines 184 and 186 represent sensors using louvered shields wherein openings are positioned in the side walls of the sensor. On the y axis the output voltage increases from zero thus as the sensing element becomes clogged with soot the output voltage increases as the resistance of the sensing element decreases due to the accumulation of soot proximate to the sensing element electrodes. Thereafter the element is regenerated by operating the heating element. FIG. 8 illustrates that the louvered sensors are more susceptible to soot clogging due to the openings in the side walls as lower output voltages are measured. Moreover, FIG. 8 also illustrates that the sensors of exemplary embodiments of the present invention with a single large opening respond to soot loading as quickly as sensors with louvered sensor shields. In addition, the sensors of exemplary embodiments of the present invention with a single large opening can regenerate as quickly as sensors with louvered sensor shields.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A soot sensor, comprising:
a sensing element configured to provide a signal indicative of an amount of soot detected by the sensing element, the sensing element terminating at a tip portion;
a shield disposed about the sensing element, the shield comprising an elongated body having a solid side wall terminating at a distal end portion, and a single opening disposed completely across the distal end portion, the single opening having a peripheral edge defined by the distal end portion of the side wall; and
an inner area defined by the shield, the area being in fluid communication with the single opening and the tip portion being completely recessed within the area at a distance from the single opening and a peripheral edge of the tip portion being at least a predetermined distance from the solid side wall, the predetermined distance preventing soot from completely blocking the single opening.

2. The soot sensor as in claim 1, wherein the side wall defines a tubular portion having an inner periphery and the single opening has an outer periphery substantially equal to the inner periphery.

3. The soot sensor as in claim 1, wherein the distance is at least 2.0 mm.

4. The soot sensor as in claim 3, wherein the side wall defines a tubular portion having an inner periphery and the single opening has an outer periphery substantially equal to the inner periphery.

5. The soot sensor as in claim 4, wherein the predetermined distance from the solid side wall is at least 1.5 mm.

6. The soot sensor as in claim 1, wherein the predetermined distance from the solid side wall is greater than 1.5 mm.

7. The soot sensor as in claim 1, wherein the single opening is circular and the single opening has a diameter of at least 3 mm greater than a largest single dimension traversing the tip portion of the sensing element from one edge of the peripheral edge of the tip portion to another peripheral edge of the tip portion.

8. The soot sensor as in claim 1, wherein the shield further comprises a flange portion extending outwardly from the end portion of the side wall.

9. The soot sensor as in claim 8, wherein the distance is at least 2.0 mm and the single opening is circular and the single opening has a diameter of at least 3 mm greater than a largest single dimension traversing the tip portion of the sensing element from one edge of the peripheral edge of the tip portion to another peripheral edge of the tip portion.

10. The soot sensor as in claim 9, wherein the side wall defines a tubular portion having an inner periphery and the single opening has an outer periphery substantially equal to the inner periphery and the peripheral edge of the tip portion is rectangular in shape and the sensing element is centrally located in the inner area.

11. The soot sensor as in claim 1, wherein the shield further comprises a first flange portion extending outwardly from the end portion of the side wall and a second flange portion extending outwardly from an opposite end portion of the side wall, opposite end portion defining another opening and the first flange portion being substantially similar to the second flange portion and either the first flange portion or the second flange portion is secured to a housing portion of the soot sensor.

12. The soot sensor as in claim 11, wherein the distance is at least 2.0 mm.

13. The soot sensor as in claim 11, wherein the predetermined distance from the solid side wall is at least 1.5 mm.

14. The soot sensor as in claim 11, wherein the side wall defines a tubular portion having an inner periphery and the single opening has an outer periphery substantially equal to the inner periphery.

15. The soot sensor as in claim 11, wherein the housing portion has a threaded portion and the shield has an outer periphery that is smaller than a periphery defined by the threaded portion.

16. The soot sensor as in claim 1, wherein the side wall has an outer periphery that varies in dimension and the outer periphery defines a dimension of an inner periphery of the area.

17. The soot sensor as in claim 14, wherein the single opening is larger than a portion of the side wall.

18. The soot sensor as in claim 17, wherein the shield has a mounting portion configured to secure the shield to a housing portion of the soot sensor.

19. The soot sensor as in claim 1, wherein the shield has a mounting portion configured to secure the shield to a housing portion of the soot sensor and the distal end of the side wall and the single opening are arranged in a plane perpendicular to an exhaust flow path.

20. The soot sensor as in claim 1, wherein the distance is at least 2.0 mm and the predetermined distance from the solid side wall is with a range defined by at least 1.5 mm and 2.9 mm.
